(19) United States
(12) Patent Application Publication
(10) Pub. No.: US 2025/0229902 A1
(43) Pub. Date: Jul. 17, 2025

(54) SEAT HEADREST

(71) Applicant: B/E Aerospace, Inc., Winston-Salem, NC (US)

(72) Inventors: Marcin Szymon Kolodziejczak, Wroclaw (PL); Marcin Adam Chodyniecki, Swidnica (PL)

(21) Appl. No.: 19/025,442

(22) Filed: Jan. 16, 2025

(30) Foreign Application Priority Data
Jan. 16, 2024 (EP) 24461510.0

(51) Int. Cl. B64D 11/06

(52) U.S. Cl. CPC B64D 11/0642

(57) ABSTRACT

A seat headrest comprising: a headrest frame (11) having: a lower frame part (12) configured to be attached to a seat back; an upper frame part (14) pivotally attached to the lower frame part to be moveable between a fully open position and a folded position; a pivot arm (50) connected at a first end (51) to the upper frame part and pivotally connected at a second end (52) to the lower frame part; and a locking mechanism (40) to releasably lock the upper frame part relative to the lower frame part in the fully open position; wherein the locking mechanism comprises a shaft (42) extending through the pivot arm and the lower frame part to define a pivot axis about which the pivot arm pivots relative to the lower frame part, and wherein the locking mechanism further comprises a locking pin (41) configured to extend through the lower frame part, the pivot arm and the upper frame part to lock the pivot arm and upper frame part with respect to the lower frame part when the upper frame part is in a first, fully open, position relative to the lower frame part, and wherein actuation of the locking mechanism by a pushing action of a user causes movement of the locking pin out of engagement with the pivot arm and the upper frame part to permit pivotal movement of the arm relative to the lower frame part about the pivot axis.

### CROSS-REFERENCE TO RELATED APPLICATIONS

The present application claims the benefit of European Patent Application No. 24461510.0, filed Jan. 16, 2024, which is herein incorporated by reference in the entirety.

### TECHNICAL FIELD

The present disclosure relates to a headrest for a seat such as, but not exclusively, for a seat in a vehicle or aircraft or any other seat where improved access to an area behind the seat may be required.

### BACKGROUND

Seats, particularly in vehicles or in other environments where a user is seated while performing tasks, such as a pilot seat in an aircraft or a helicopter pilot seat, are often provided with a head rest portion extending from the seat back to support the user's head while seated for increased safety and comfort. Some headrests are formed integrally with the seat back. Others may be mounted permanently or removably to the seat and may be adjustable in height or angle to accommodate users of different sizes.

While such headrests are desirable in terms of comfort and safety, there may be situations where the headrest obstructs the user's access to an area behind the seat. In a helicopter, for example, there is often a shelf or storage area behind a seat, or, in aircraft or other environments, the user may need to access controls, lights, accessories, or other things from the area behind the seat without actually moving to the area behind the seat. Because of the task that the user is performing, or because of space constraints or for other reasons, the user may need to access the area behind the seat by just reaching back behind the seat from a seated position or from a position at the front of the seat. The headrest may, however, obstruct access to the area behind the seat.

There is a need for a headrest design that improves access to an area behind a seat from an area at the front of the seat.

### SUMMARY

According to the disclosure, there is provided a headrest a headrest frame including: a lower frame part configured to be attached to a seat back; an upper frame part pivotally attached to the lower frame part to be moveable between a fully open position and a folded position; a pivot arm connected at a first end to the upper frame part and pivotally connected at a second end to the lower frame part; and a locking mechanism to releasably lock the upper frame part relative to the lower frame part in the fully open position; wherein the locking mechanism includes a shaft extending through the pivot arm and the lower frame part to define a pivot axis about which the pivot arm pivots relative to the lower frame part, and wherein the locking mechanism further includes a locking pin configured to extend through the lower frame part, the pivot arm and the upper frame part to lock the pivot arm and upper frame part with respect to the lower frame part when the upper frame part is in a first, fully open, position relative to the lower frame part, and wherein actuation of the locking mechanism by a pushing action of a user causes movement of the locking pin out of engagement with the pivot arm and the upper frame part to permit pivotal movement of the arm relative to the lower frame part about the pivot axis.

The shaft and the locking pin of the locking mechanism may be connected to move together, e.g., by a common plate.

The locking mechanism may comprise a push button, for actuation by the user, the push button mounted to the shaft and the locking mechanism being spring-loaded to extend through the lower frame part, the pivot arm, and the upper frame part to lock the pivot arm and upper frame part with respect to the lower frame part.

Also provided is a seat to which such a headrest is mounted, e.g., a helicopter seat.

### BRIEF DESCRIPTION OF THE DRAWINGS

FIG. 1 shows a seat to which a headrest is mounted, in accordance with one or more embodiments of the present disclosure.

FIG. 2 shows a headrest, in accordance with one or more embodiments of the present disclosure.

FIG. 3 shows a headrest in a first position, in accordance with one or more embodiments of the present disclosure.

FIG. 4 shows a headrest in a second position, in accordance with one or more embodiments of the present disclosure.

FIG. 5 shows structure of a headrest in the first position, in accordance with one or more embodiments of the present disclosure.

FIG. 6 shows structure of a headrest in the second position, in accordance with one or more embodiments of the present disclosure.

FIG. 7 shows a detail of a locking feature for a headrest, in accordance with one or more embodiments of the present disclosure.

FIG. 8 shows a detail of an arm of a headrest, in accordance with one or more embodiments of the present disclosure.

FIG. 9 is an example of a headrest viewed from a side, in accordance with one or more embodiments of the present disclosure.

### DETAILED DESCRIPTION

Examples of the headrest according to the disclosure will now be described with reference to the drawings. It should be noted that these are examples only and that variations are possible within the scope of the claims.

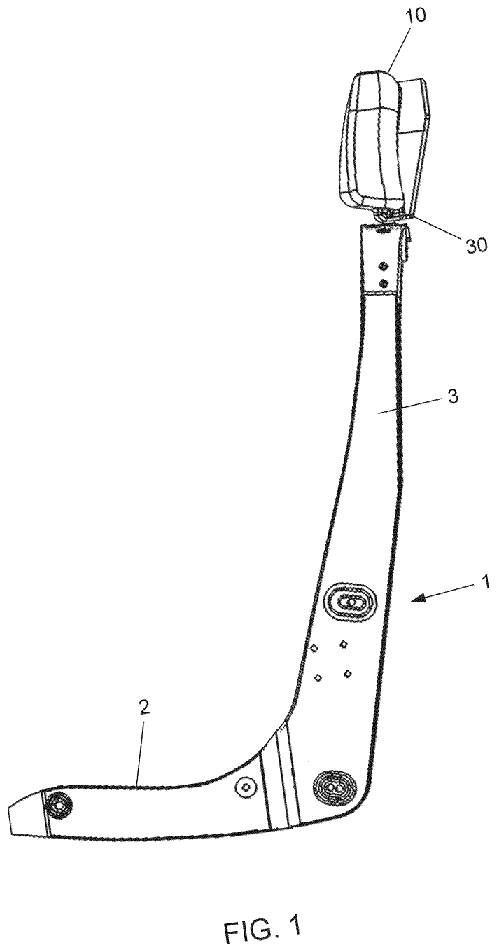

FIG. 1 shows an example of a seat 1 to which the headrest 10 of the disclosure can be mounted. The seat 1 shown in the example is the type of seat that may be fitted in a helicopter or other aircraft or vehicle, but the headrest 10 can be used with any type of seat in any environment.

The seat 1 has a seat base or seat pan 2 and a seat back 3. The seat 1 may, in other examples, also be provided with one or two arm rests. The seat 1 may be adjustable in position and/or height and/or angle and/or the seat base and the seat back may be adjustable in position, angle, height, relative to each other as is known for seats.

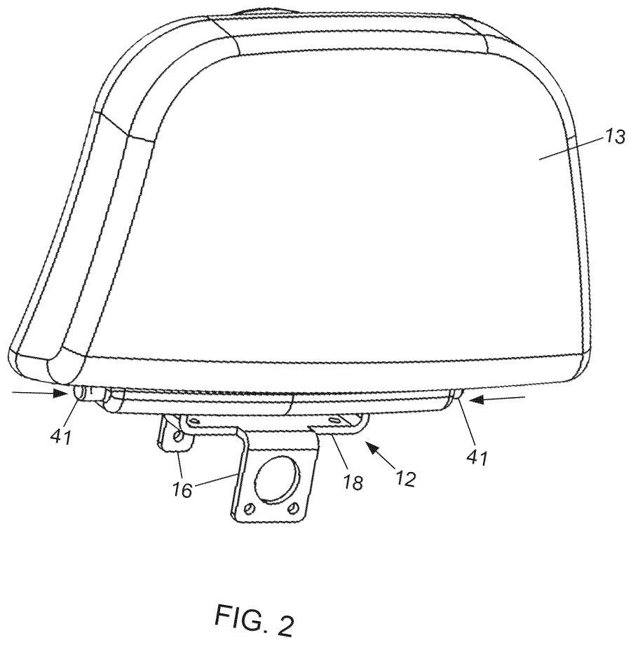

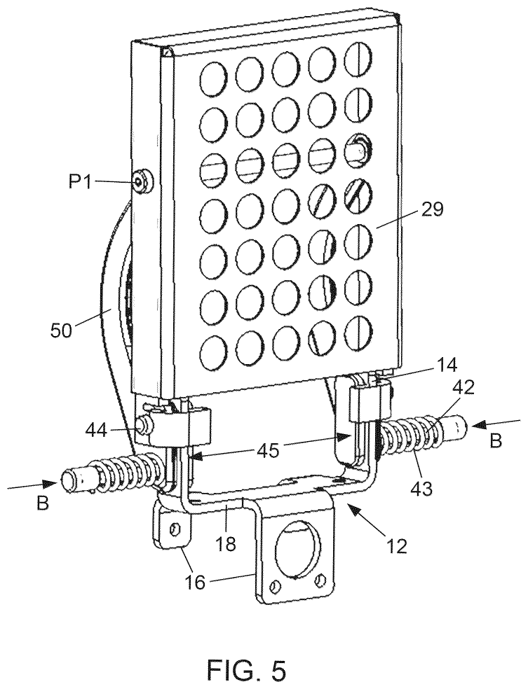

The headrest 10 is mounted to the top 30 of the seat back 3 as will be described further below. This is positioned to provided support for the back of a user's head when they are seated in the seat 1. Typically, headrests are formed either integrally with the seat back 3 or are a separate part that can be fitted to the top of the seat back 3 (e.g., by insertion of legs extending from the headrest 10 into slots or holes in the seat back 3 dimensioned to receive the legs). A headrest 10 typically has a frame to define the shape and structure of the headrest and some form of cushioning or padding over or around the frame to provide comfort. Similar to typical headrests, the headrest 10 of this disclosure has a frame 11 (see FIG. 5) and, for use, cushioning 13 (see FIG. 2) of some sort would be provided around or on the frame 11. The cushioning 13 can be of any type suitable for fitting around or onto the frame 11 and may or may not be removable for repair, replacement, cleaning, or the like.

Referring to FIGS. 2-8, the frame 11 comprises a first, lower frame part 12 including attachment parts for attachment to the seat back 3. The attachment parts may include legs 16, rods, or other extensions, connected to each other via a strut 18, the legs 16 being arranged to attach to the seat back (e.g., by fitting over the top of the seat back 3 and attached by fastening means such as bolts or screws). The frame 11 also comprises a second, upper frame part 14 pivotally attached to the lower frame part 12. The upper frame part 14 defines the part of the headrest 10 to which the cushioning 13 may be mounted and against which the user's head will rest and so should be of a suitable shape to perform this function. In the example shown, the upper frame part 14 is of a generally rectangular shape having two side arms 26 connected by an uppermost strut 28 defining the top of the frame. An additional reinforcement panel 29 may also be provided across the two arms 26. This panel 19 may be a sheet of metal or plastic and can, to reduce the amount of material and, therefore cost and weight, have a lattice or perforated structure. In this example, the upper frame part 14 is pivotally attached to the lower frame part 12 at the two arms 26. Other frame shapes and structures, and attachments to the lower frame part 12, are also possible.

The frame 11 is also provided with a locking/unlocking mechanism 40 to selectively unlock the upper frame part 14 relative to the lower frame part 12 to permit relative pivotal movement and lock the upper frame relative to the lower frame preventing pivotal movement.

The locking/unlocking mechanism 40 is configured to be operated by a user to release locking to allow the upper frame part 14 to be pivoted or rotated relative to the lower frame part 12 if, for example, the user needs to fold down the upper frame part 14 to be able to easily access the area behind the headrest 10. In one example, the locking/unlocking mechanism 40 is configured such that it locks the upper frame part 14 in a fully opened position—e.g., in the normal headrest position for supporting the head.

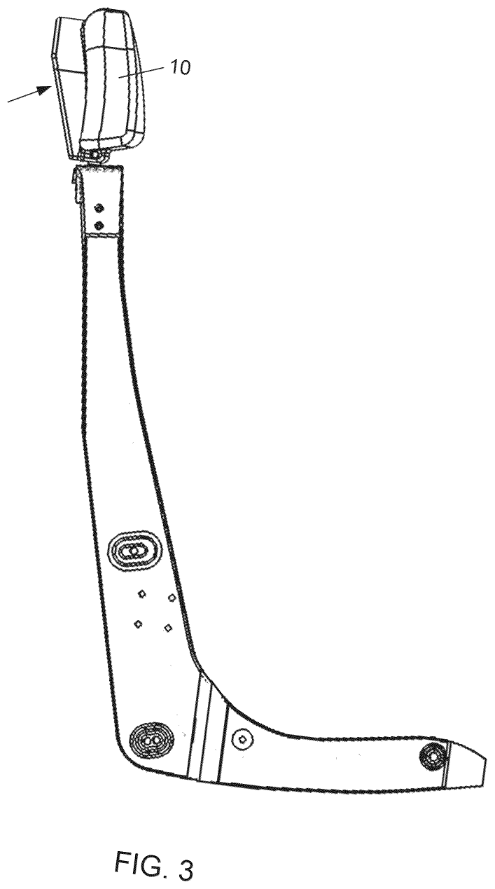

The default position of the headrest is with the upper frame part 14 fully open relative to the lower frame part 12 (such as shown in FIG. 3) and, in this position, the locking mechanism 40 is in a locked position, to be described further below.

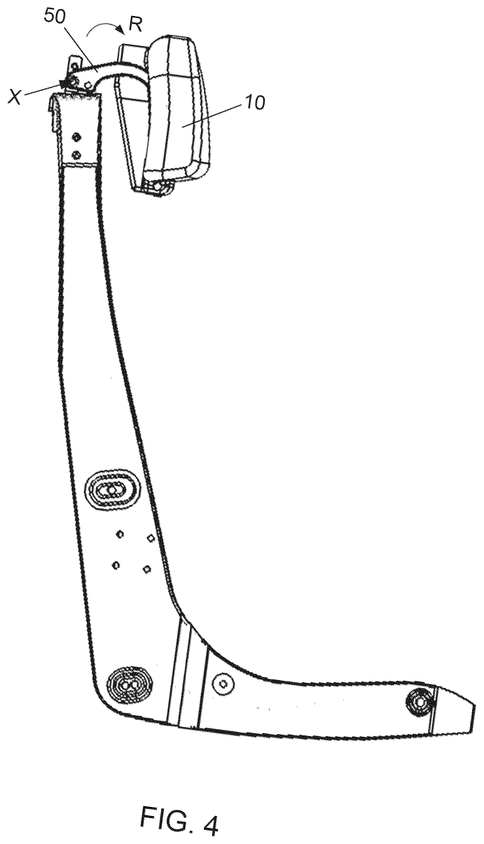

The headrest according 10 to this disclosure is configured to be folded or pivoted relative to the seat back 3 by the user releasing the locking mechanism 40 by pressing two spring-loaded buttons 41, one on each side of the headrest 10 in the region where the upper frame part 14 is pivotally attached to the lower frame part 12. The headrest 10 can then be pivoted or folded, by the user, about the top of the seat back 3 to a position in front of the seat back 3, as shown in FIG. 4. By folding the headrest 10 out of the area above the top of the seat back 3, the user has better access to the area behind the seat 1.

The headrest 10 rotates between the fully open position and the folded position about a pivot axis X defined by the locking mechanism 40.

The mechanism that allows the headrest 10 to be moved between the fully open position and the folded position will now be described in more detail with particular reference to FIGS. 5 to 8.

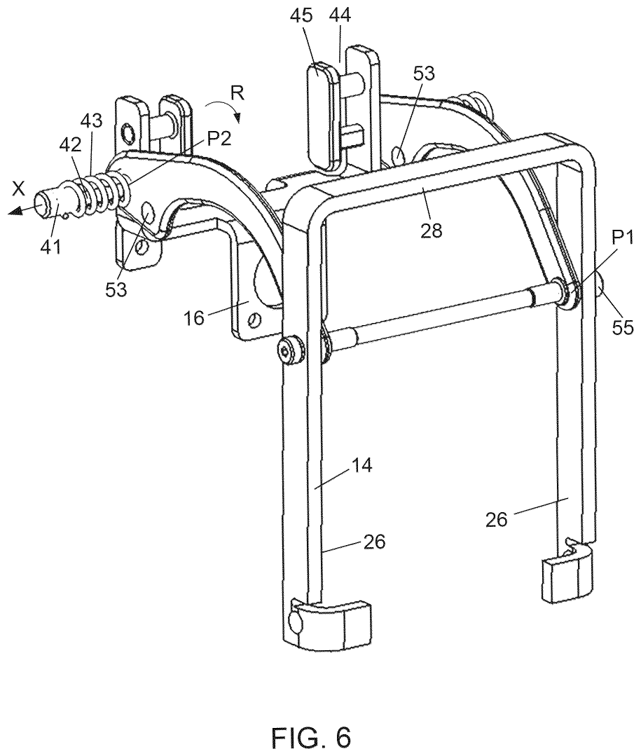

As seen in FIGS. 5 and 6, the upper frame part 14 is attached, at a first pivot point P1 to a first end 51 of a pivot arm 50, by a fastener such as a bolt or a pin 55 that passes through an opening in the upper frame part 14 and a corresponding opening in the first end 51 of the arm 50. The fastener is such that the upper frame part 14 is pivotable relative to the arm 50.

The other end 52 of the pivot arm 50 is attached to the lower frame part 12 at a second pivot point P2, the lower frame part 12 being pivotally attached to the second end of the arm by a shaft 42 of the spring-loaded push button 41. This shaft 42 defines the pivot axis X about which the pivot arm 50 pivots relative to the lower frame part 12.

The movement of the headrest 10 relative to the seat 1 includes a pivotal movement of the upper frame part 14 about the pivot axis X relative to the lower frame part 12 (which is fixed relative to the seat back 3) when the locking mechanism 40 is released by the user pushing the push buttons 41, described further below and a further pivotal movement of the upper frame part 14 relative to the pivot arm 50 about the first pivot point P1.

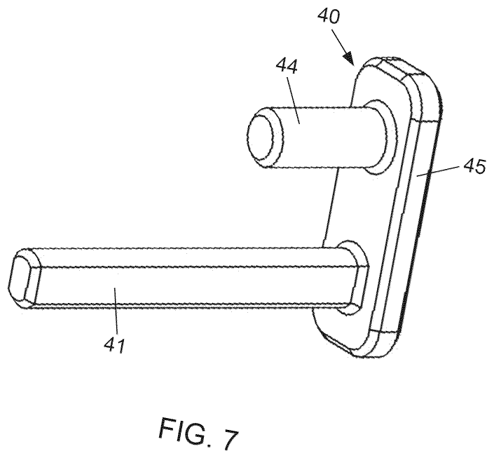

The locking mechanism 40 is provided to lock the upper frame part 14 relative to the lower frame part 12 when the headrest 10 is in the fully open position and when the spring-loaded buttons 41 are in their default state under the force of springs 43, being biased outwards relative to the headrest frame. In this default state of the push buttons 41, a locking pin 44 of the locking mechanism 40, which is fixed relative to the push button 41 (e.g., as in this example, by the locking pin 44 and the push button 41 being fixed to a common plate 45 (as shown in FIG. 7). Extends through a hole in the lower frame part 12 and also a locking pin hole 53 in the pivot arm 50 and an aligned hole in the upper frame part 14. The locking mechanism 40 therefore locks the upper frame part 14 and the lower frame part 12, as well as the pivot arm 50 sandwiched therebetween at the second pivot point, against relative pivotal movement, shown in FIG. 5. The spring 43 of the locking mechanism 40 therefore biases the locking pin 44 into this locking engagement.

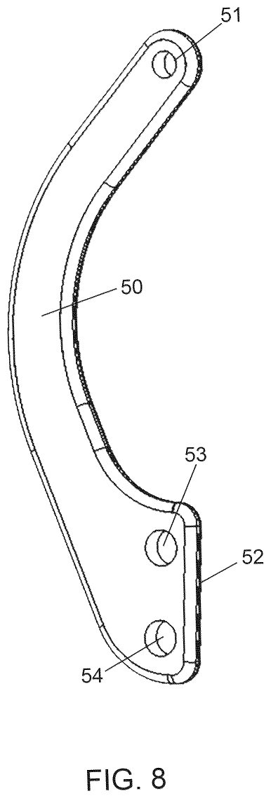

FIGS. 7 and 8 show the locking mechanism 40 and pivot arm 50 separately for ease of explanation. FIG. 7 shows the push button shaft 42 and the locking pin 44 extending from a common plate 45. In use, but not shown in FIG. 7 for simplicity, the button 41 is fitted to the shaft 42 (e.g., by a threaded fastening or is otherwise attached to the shaft 42). The shaft 42 extends from the plate 45 by a greater distance than the locking pin 44 as the shaft 42 carries the push button 41 to be pressed by the user and so this has to extend outwards of the frame structure for access by the user. The locking pin 44 needs to be of sufficient length to extend through the lower frame part 12, the arm 50, and the upper frame part 14, when biased by the spring 43 into the default locking position, but to be released from engagement with the arm 50 and the upper frame part 14 when a user presses the push button 41. By pressing the push button 41 (direction B), the user compresses the spring 43, thus forcing the locking mechanism 40 inwards (direction B) to move the locking pin 44 out of engagement with the arm 50 (e.g., out of the hole 53 in the arm 50) and out of engagement with the upper frame part 14.

To fold the headrest 10 to the folded position, the user therefore presses against the push button 41 on either side of the headrest 10, against the spring bias. Pushing the button 41, and hence the shaft 42, the locking pin 44, which is connected to the push button 41 (e.g., via the common plate 45, is also moved in direction B and therefore out of hole 53 in the pivot arm 50). The engagement between the upper frame part 14 and the pivot arm 50 at the second end 52 of the pivot arm 50 is, therefore, released but the upper frame part 14 remains attached to the pivot arm 50 at the first end 51. Further, the locking engagement between the pivot arm 50 and the lower frame part 12, through the hole 54 is also released. The pivot arm 50 and the lower frame part 12 are, therefore, now only attached to each other by means of the shaft 42 through the hole 53 defining the pivot axis X and so the pivot arm 50 can pivot relative to the fixed lower frame part 12 about this pivot axis X (e.g., as defined by the push button shaft 42). The pivot arm 50 and, therefore, the upper frame part 14, can then be pivoted, by the user, about the pivot axis (direction R in FIG. 6) relative to the seat back 3 to which the lower frame part 12 is fixed, and, at the same time, the upper frame part 14 can pivot relative to the arm 50 at the first pivot point P1 to lie relatively flat relative to the seat back 3, as shown in FIGS. 4 and 6).

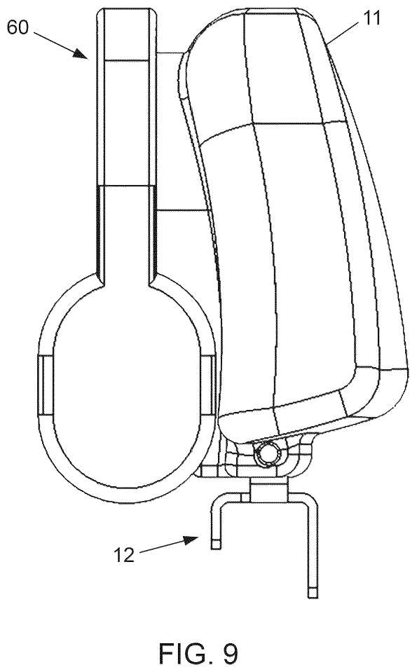

The headrest 10 may be provided with additional features such as a storage feature 60 for a headset or the like as shown in FIG. 9.

The headset design described herein allows a user to easily, and without special tools, fold the headrest 10 to allow access to an area behind the seat 1. The headrest 10 can be easily mounted to a seat 1 and is simple to assemble and operate. The upper frame part 14 and the lower frame part 12 can be formed of simple, lightweight bent metal to keep costs and weight to a minimum.

1. A seat headrest comprising:
a headrest frame comprising:
a lower frame part configured to be attached to a seat back;
an upper frame part pivotally attached to the lower frame part to be moveable between a fully open position and a folded position;
a pivot arm connected at a first end to the upper frame part and pivotally connected at a second end to the lower frame part; and
a locking mechanism to releasably lock the upper frame part relative to the lower frame part in the fully open position; wherein the locking mechanism comprises:
a shaft extending through the pivot arm and the lower frame part to define a pivot axis about which the pivot arm pivots relative to the lower frame part; and
a locking pin configured to extend through the lower frame part, the pivot arm and the upper frame part to lock the pivot arm and upper frame part with respect to the lower frame part when the upper frame part is in a first, fully open, position relative to the lower frame part, and wherein actuation of the locking mechanism by a pushing action of a user causes movement of the locking pin out of engagement with the pivot arm and the upper frame part to permit pivotal movement of the arm relative to the lower frame part about the pivot axis.

2. The headrest of claim 1, wherein a pivot arm and a locking mechanism are provided on each side of the headset frame.

3. The headrest of claim 1, wherein the shaft and the locking pin of the locking mechanism are connected to move together.

4. The headrest of claim 3, wherein the shaft and the locking pin are connected by a common plate.

5. The headrest of claim 1, wherein the locking mechanism comprises a push button, for actuation by the user, the push button mounted to the shaft and the locking mechanism, wherein the push button is being spring-loaded to extend through the lower frame part, the pivot arm, and the upper frame part to lock the pivot arm and the upper frame part with respect to the lower frame part.

6. The headrest of claim 1, wherein the lower frame part is in the form of a clamp arranged to fit over the top is the seat back, in use.

7. The headrest of claim 1, wherein the upper frame part is in the form of a U-shaped bracket having two legs arranged to be attached to the lower frame part by the pivot arm.

8. The headrest of claim 1, wherein the pivot arm has a first hole in the first end for pivotal attachment to the upper frame part.

9. The headrest of claim 1, wherein the pivot arm has a second hole in the second end through which the shaft passes to define the pivot axis.

10. The headrest of claim 9, wherein the pivot arm has a third hole in the second end, through which the locking pin passes.

11. The headrest of claim 1, further comprising a panel across the upper frame part to define a headrest surface.

12. The headrest of claim 1, further comprising cushioning fitted over the upper frame part.

13. The headrest of claim 1, further comprising a holder to which a headset can be mounted.

14. A seat comprising:
a seat back;
a seat base connected to the seatback; and
a headrest frame removably mounted to the top of the seatback comprising:
a lower frame part configured to be attached to a seat back;
an upper frame part pivotally attached to the lower frame part to be moveable between a fully open position and a folded position;
a pivot arm connected at a first end to the upper frame part and pivotally connected at a second end to the lower frame part; and
a locking mechanism to releasably lock the upper frame part relative to the lower frame part in the fully open position; wherein the locking mechanism comprises:
a shaft extending through the pivot arm and the lower frame part to define a pivot axis about which the pivot arm pivots relative to the lower frame part; and
a locking pin configured to extend through the lower frame part, the pivot arm and the upper frame part to lock the pivot arm and upper frame part with respect to the lower frame part when the upper frame part is in a first, fully open, position relative to the lower frame part, and wherein actuation of the locking mechanism by a pushing action of a user causes movement of the locking pin out of engagement with the pivot arm and the upper frame part to permit pivotal movement of the arm relative to the lower frame part about the pivot axis.

15. The headrest of claim 1, wherein the headrest is removably mounted to the top of the seat back.
